(19) United States
(12) Patent Application Publication
(10) Pub. No.: US 2009/0028489 A1
(43) Pub. Date: Jan. 29, 2009

(54) High speed fiber optic grating sensor system

(76) Inventors: Eric Udd, Fairview, OR (US); Jerry J. Benterou, Livermore, CA (US)

Correspondence Address: Eric Udd, P.O. Box 382, Fairview, OR, 97024, US

(21) Appl. No.: 12/217,666

(22) Filed: Jul. 8, 2008

Related U.S. Application Data
(60) Provisional application No. 60/959,862, filed on Jul. 17, 2007.

(51) Int. Cl. G02B 6/00

(52) U.S. Cl. 385/12

(57) ABSTRACT

A fiber optic grating sensor system is used to localize and measure the environment associated with high speed events including pressure, temperature, velocity and position. This system has the capability to provide timing and physical location markers allowing the character of a rapidly changing event to be accurately measured with specific reference to time and location of that event. The system consists of a fiber grating sensor assembly that may consist of a fiber grating array or chirped fiber grating. Markers are put in place by using short fiber gratings that either occupies a different spatial or spectral space so that environmental measurements can be accurately related to time and space. The reflective spectra can be interpreted rapidly through the use of spectral filters, the disappearance of the fiber grating assembly due to an energetic event or arrays of high speed detectors supported by dispersive elements.

This application claims the benefit of U.S. Provisional Patent Application No. 60/959,862 by Eric Udd and Jerry John Benterou, entitled “High Speed Diagnostic System to Support Measurements of Energetic Materials and Damage”, which was filed on Jul. 17, 2007.

The United States has rights in this invention pursuant to Contract No DE-AC52-07NA27344 between the United States Department of Energy and Lawrence Livermore National Security, LLC.

### BACKGROUND OF THE INVENTION

This disclosure describes means to measure the location and velocity of a blast wave after detonation. It also describes configurations that can be used to support the measurement of location pressure and temperature by appropriately configuring the optical fiber grating sensors and utilizing appropriately configured read out techniques. Fiber grating sensor systems are described in detail in U.S. Pat. Nos. 5,380,995, 5,402,231, 5,828,059, 5,841,131, 6,144,026, and 6,335,524. Also U.S. patent application Ser. No. 11/071,278 by Eric Udd and Sean Calvert filed on Mar. 3, 2005 and abandoned teaches a fiber grating sensor system for detection, localization and characterization of high speed pressure waves. The present invention extends the capabilities of the high speed system to measure pressure, temperature, velocity and position of a high speed event such as a blast wave.

The system has been demonstrated by the inventors with an operational bandwidth of 250 MHz that has allowed the velocity and position of a blast wave to be accurately measured interior to an energetic material after detonation with the duration of the events being on the order of 5 to 10 micro-seconds. The present invention in addition to measuring velocity and position can be extended to support the measurement of pressure and temperature allowing a much more complete set of measurements that are necessary to perform accurate diagnostics.

### BRIEF DESCRIPTION OF THE PRESENT INVENTION

In the present invention a high speed fiber grating sensor system is described that is capable of measuring the position, velocity, pressure and temperature of a high speed event that may be a blast wave generated by detonation of a highly energetic material. The invention is particularly directed toward the measurement of blast waves that have sufficient energy to destroy the optical fiber as they pass although the system will operate and provide more limited information for less energetic events.

The invention consists of a light source that illuminates one or more fiber gratings, in one or more fiber lines, that are placed and oriented along a path associated with the blast wave that is to be measured. The reflected signals from the fiber gratings encountering the blast wave are then directed toward one of more wavelength filters that are used to localize and characterize the high speed blast wave. In order to separate pressure from temperature multiple fiber gratings or multi-parameter fiber grating sensors may be used. This can involve multiple read out detection lines that can as an example be used to separate out polarization states or it can involve separate fiber grating lines designed for different environmental responses to the blast wave. Therefore it is an object of the invention to provide a very high speed system that is capable of characterizing a blast or pressure wave.

Another objective is to measure the velocity of a blast or pressure wave.

Another objective is to measure the localized pressure of the blast or pressure wave.

Another objective is to measure the localized temperature of the blast or pressure wave.

Another objective is to characterize the pressure distribution of the leading edge of a blast or pressure wave.

Another objective is to characterize the temperature distribution of the leading edge of a blast or pressure wave.

Another objective is to simultaneously measure two or more of the following parameters, pressure, temperature, velocity and position of a blast or pressure wave.

### BRIEF DESCRIPTION OF THE DRAWINGS

The present invention will be readily understood by the following detailed description, taken in conjunction with accompanying drawings, illustrating by way of examples the principles of the invention. The drawings illustrate the design and utility of preferred embodiments of the present invention, in which like elements are referred to by like reference symbols or numerals. The objects and elements in the drawings are not necessarily drawn to scale, proportion or precise positional relationship; instead emphasis is focused on illustrating the principles of the invention.

FIG. 1 is an illustration of a prior art fiber grating that has a uniform period along its length.

FIG. 2 is an illustration of a prior art chirped fiber grating that has a nonuniform period along its length.

FIG. 3 is a graph showing the reflection and transmission spectrum of a 50 mm chirped fiber grating.

FIG. 4 shows the spectrum of a 50 mm chirped fiber grating and a fiber light source.

FIG. 5 shows the spectrum of a 100 mm chirped fiber grating before and after it has been cut back by 49 mm.

FIG. 6 is an overall block diagram of a high speed fiber grating sensor system that was used to monitor a blast event.

FIG. 7 is a block diagram showing the position of the chirped fiber grating with respect to the cylinder of nitromethane to support a blast test.

FIG. 8 shows test results of a blast test using a 37 mm chirped fiber grating inserted into a tube of nitromethane.

FIG. 9 is a waterfall plot of a chirped fiber grating that was trimmed to successively shorter lengths.

FIG. 10 shows reflection data obtained from a chirped fiber grating as it is being trimmed.

FIG. 11 is a system block diagram showing a set up to measure the leading edge of a blast wave that destroyed a chirped fiber grating.

FIG. 12 is an illustration of the changes that occur to the spectrum of a uniform fiber grating which is subject to the leading edge of a highly energetic blast wave with a well defined leading pressure wave edge.

FIG. 13 illustrates how an array of fiber gratings may be used to determine the position and amplitude of a pressure wave by varying spacing, length and reflectivity.

FIG. 14 shows how a nonuniform pressure wave may induce a complex reflected spectrum from a fiber grating sensor.

FIG. 15 shows a high speed system that is capable of measuring the entire spectral profile of a fiber grating assembly.

FIG. 16 is a diagram illustrating the usage of a circulator to support a high speed read out system.

FIG. 16a,b,c is an illustration of the spectral profile associated with a chirped fiber grating and difficulties associated with the spectral edges.

FIG. 17 is a diagram that illustrates the usage of short marker fiber gratings that are superposed on a chirped fiber grating, to simplify and improve localization of a high speed event.

FIG. 18 is a graphical illustration of the response of a high speed readout system to a fiber grating sensor assembly similar to that shown in association with FIG. 17.

FIG. 19 is an diagram of a high speed fiber grating sensor system that incorporates short marker fiber gratings superposed on a chirped fiber grating each operating on separate spectral bands.

FIG. 20 is an illustration of side hole optical fiber and its spectral performance when under pressure.

FIG. 21 is an illustration of birefringent optical fiber and its spectral performance when under pressure.

FIG. 22 is a diagram of a system using side hole or birefringent fiber to measure pressure at very high speed.

FIG. 23 is an illustration of the difference between orienting a chirped fiber grating with its short or long wavelength edge toward an incoming high pressure wave.

FIG. 24 is a diagram of a high speed fiber grating sensor system designed to support the measurement of two polarization state reflected from a fiber grating sensor assembly so that two environmental parameter that may be pressure and temperature may be measured.

FIG. 25 is a diagram of a high speed system consisting of multiple fiber lines that contain fiber grating sensor assemblies that may be spatially separated to support measurement of a high speed event.

FIG. 26 is a diagram of a high speed system consisting of multiple fiber lines that contain fiber grating sensor assemblies that may be spatially separated to support measurement of a high speed event that incorporates a series of spectrally shaped filters.

FIG. 27 is a diagram of an n port high speed fiber grating sensor system that may be used to support n fiber grating sensor subassemblies that may be spatially separated.

FIG. 28 is a diagram of an n port high speed fiber grating sensor system that may be used to support n fiber grating sensor subassemblies that may be spatially separated that incorporates spectral filters and optically efficient beam directors that may be 3 port optical circulators.

### DETAILED DESCRIPTION OF THE INVENTION

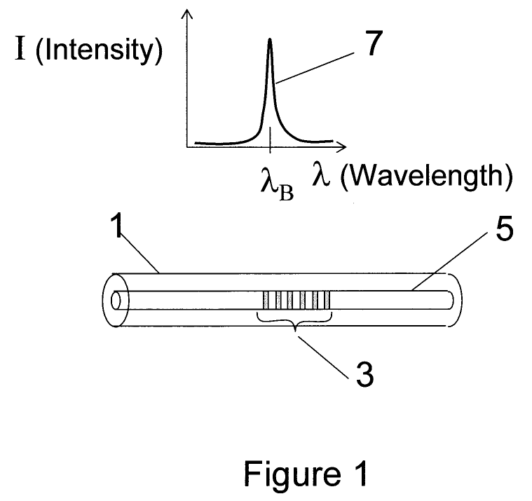

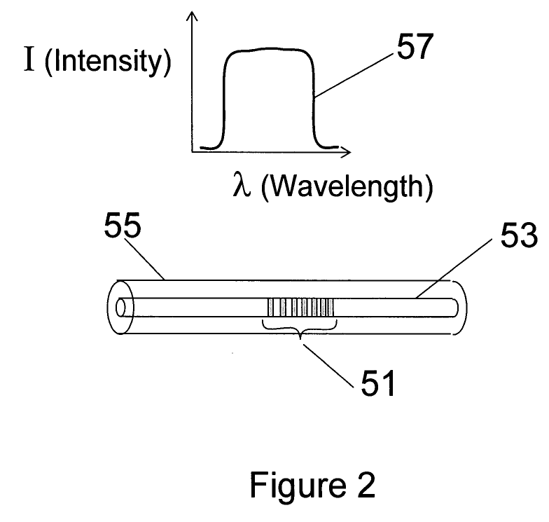

FIG. 1 is a diagram of an optical fiber 1 that contains a grating 3 that has a uniform period of index of refraction variation along a length of the core 5 of the optical fiber 1. When the fiber grating is illuminated with a light source, that may be spectrally broadband or a tunable laser source, the overall spectrum of light reflected from the fiber grating 3 is a relatively narrow spectral band 7. A much broader spectral reflection may be obtained as shown in FIG. 2 by using a chirped fiber grating 51 that is written in the core 53 of an optical fiber 55. In this case the period of index of refraction variations of the chirped fiber grating 51 vary along the length of the core 53 of the optical fiber 55. When a spectrally broadband light source illuminates this type of chirped fiber grating the reflected spectral profile 57 is much wider.

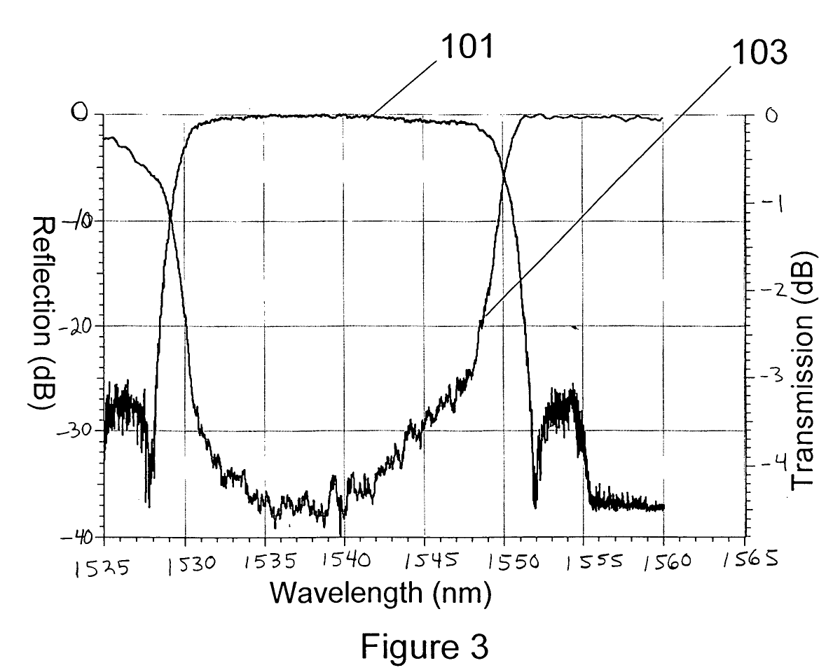

Because portions of the fiber grating may effectively spectrally “shade” successive regions the reflection and transmission of a chirped fiber grating may vary and can be designed to be “flat” over a specific spectral range. FIG. 3 shows the spectrum of the reflection 101 associated with an actual chirped fiber grating of 50 mm length. Note also that the transmission 103 of the same 50 mm long chirped fiber grating has a linear slope. Thus it is important to understand the orientation of a chirped fiber grating in a fiber grating measurement system as this can dramatically alter its spectral properties.

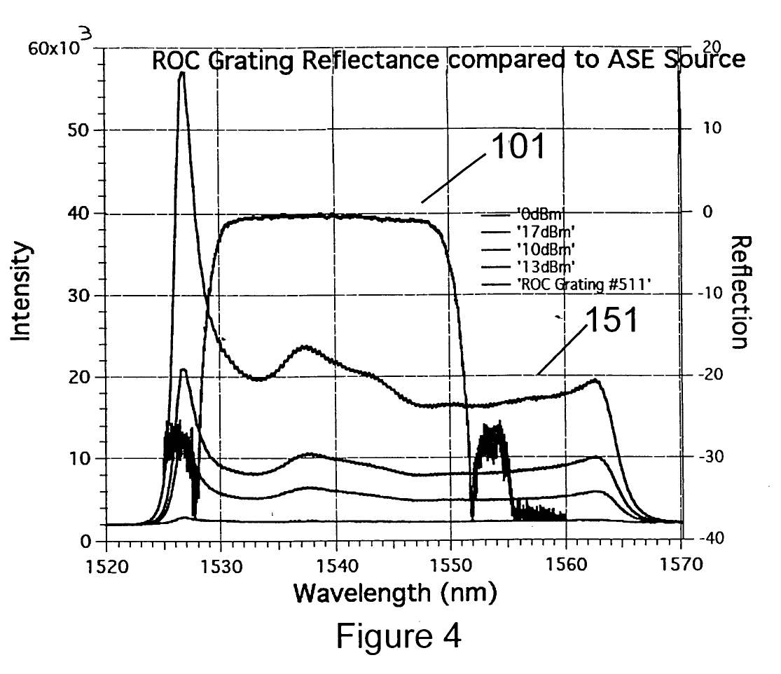

FIG. 4 illustrates the output spectrum 151 of a typical ASE light source that has been “gain flattened” using an external fiber grating. The spectrum 151 is relatively flat over the region centered about 1550 nm but exhibits significant variations in amplitude at wavelengths shorter than about 1540 nm. This is typical for this type of light source which has the advantage of being very low noise while outputting high optical power levels. The reflection spectrum 101 from the 50 mm chirped fiber grating that is illuminated by this ASE light source is shown for comparison.

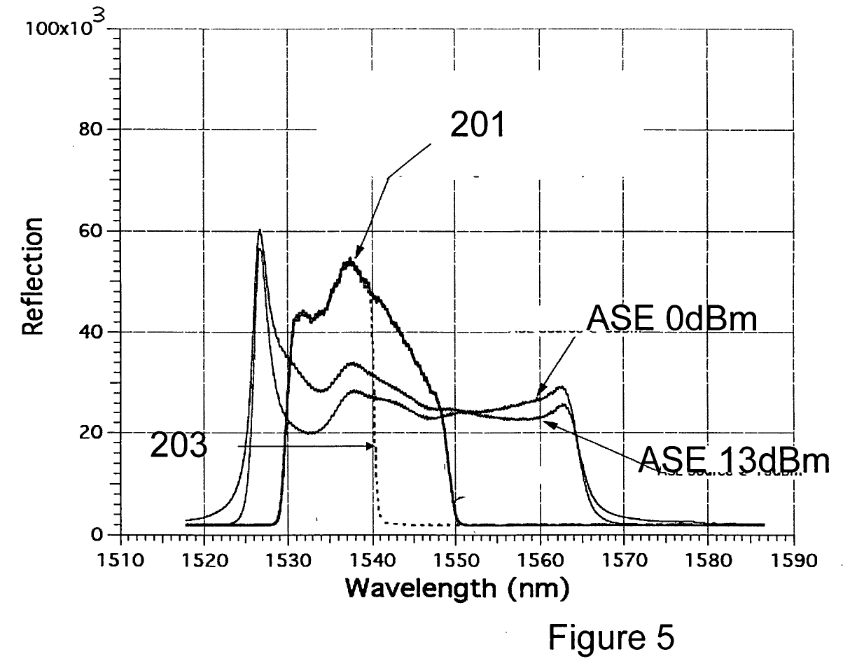

Chirped fiber gratings can be written over long lengths of many cm and in some cases have been written to lengths of over 1 m. To demonstrate the principles of measuring velocity in a blast wave 50 mm and 100 mm chirped fiber gratings were obtained. By inserting the chirped fiber grating into an explosive material that is detonated from one end the blast wave may be monitored as it propagates across the sample destroying the chirped fiber grating and effectively reducing its spectral reflection. FIG. 5 illustrates this principle. A 100 mm chirped fiber grating is physically cut back in 2 to 3 mm increments through a distance of approximately 49 mm. The spectral reflection band from the 100 mm chirped fiber grating 201 is effectively halved as shown in the spectral reflection band 203. Thus by monitoring the changes in the spectral reflection band the position along the chirped fiber grating may be determined during a blast wave which in turn can be used with a time base to generate velocity.

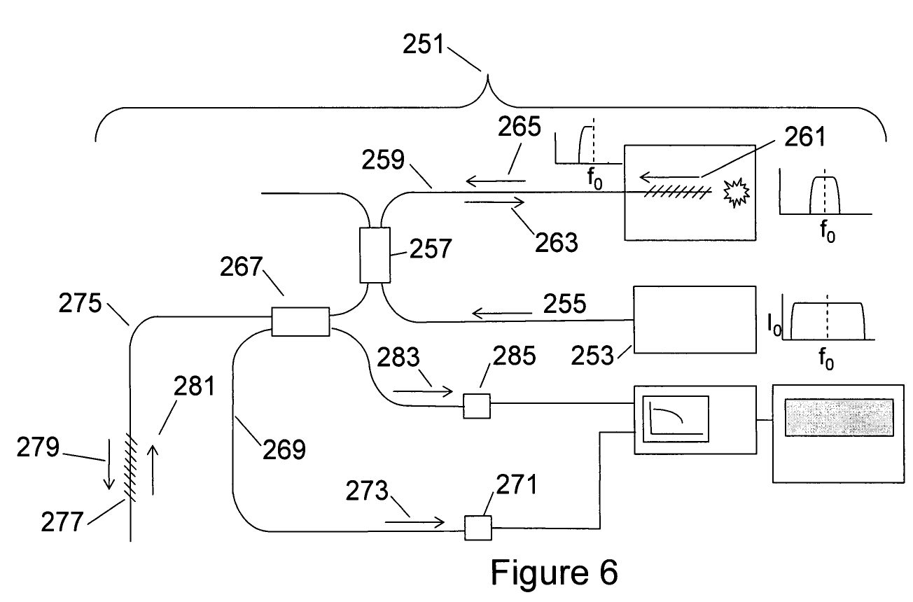

The overall layout of the test system is shown in FIG. 6. Here a broad band light source 253 that may be an ASE light source which is a gain flattened 1550 nm erbium fiber light source pumped by a 980 nm laser diode is used to inject the light beam 255 into a beamsplitter 257 that may be a 50/50 coupler. One of the beamsplitter 257 output fiber legs 259 is attached to a chirped fiber grating 261 that is placed in an area generating a high speed energetic pressure wave and the broadband light beam 263 propagates to the chirped fiber grating 261. When the detonation begins, a portion of the chirped fiber grating 261 is destroyed and the spectral reflectance decreases and a corresponding light beam 265 is reflected. The light beam 265 from the chirped fiber grating 261 is directed back to the beamsplitter 257 and into a second beamsplitter 267 that may be a 50/50 coupler. One output leg 269 of this second beamsplitter 267 is attached to a reference detector 271 that monitors the changes in the spectral reflection via the light beam 273 directly. The second output fiber leg 275 contains a second filter 277 that may be a chirped fiber grating that has a spectral reflection that overlays that of the chirped fiber grating 261 that is placed in the high pressure wave area (that may be generated by a blast wave). The light beam 279 that reflects from the second chirped fiber grating 277 as the light beam 281 is then directed back into the second beamsplitter 267 and a portion of this reflection 281 is then directed as the light beam 283 to a second detector 285 used to monitor this reflected signal. Since the chirped fiber grating 261 used as the sensor and the second filter 277 that may be a chirped fiber grating used as the reflector overlay spectrally light that is associated with the energetic event, that may be a blast wave, that is not in the spectral band of the chirped fiber grating sensor is filtered from the output detector. By comparing the reference and reflected signals on the detectors light induced by the pressure wave that may be a blast wave in the detection band can be monitored.

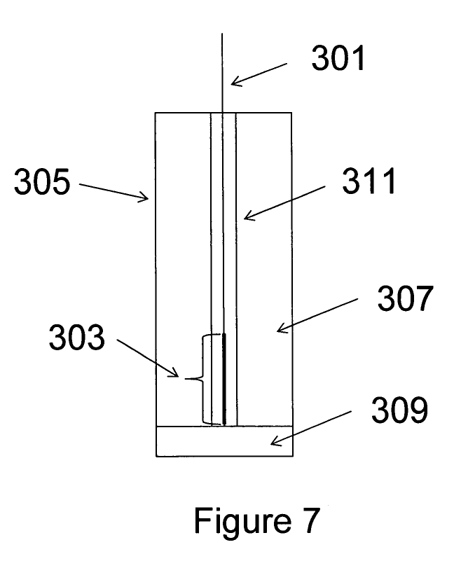

A blast test was conducted to verify the performance of the invention. The test involved placement of an optical fiber 301 with a chirped fiber grating 303 with a length of approximately 37 mm into a cylindrical container 305 of nitromethane 307 as shown in FIG. 7. One end of the chirped fiber grating was placed at the bottom of the cylinder adjacent to the igniter 309. A positioning tube 311 held the fiber near the center of the cylinder.

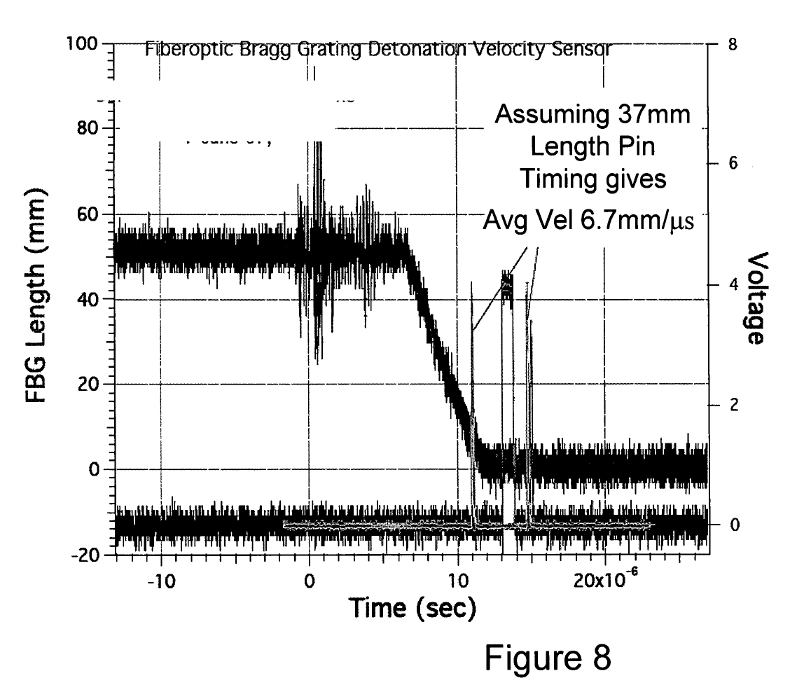

The test results from the test shot are shown in FIG. 8. Both the reference and reflected signal detectors associated with FIG. 7 showed the chirped fiber grating being destroyed at the same rate. This would indicate that the light associated with the nitromethane blast is not affecting the output reference signal in a significant way. The manufacturer of the chirped fiber grating was originally targeting an overall physical length of 100 mm. However when cut back tests were performed on a second identical “100 mm” chirped fiber grating the spectrum did not change until it was cut back to approximately 14 mm. This indicates that the length associated with the spectral band of the cut back fiber grating spectrum associated chirped fiber grating #509 was about 36 or 37 mm. This matches up very well with the velocity associated with the pin timing used to support the first blast test.

During the course of performing these tests it became evident that the chirped fiber grating specified at 100 mm actually had a physical length of approximately 74 mm. This was determined by using two sets of physical “cut back” tests on the 100 mm chirped fiber gratings. This was done by laying out the 100 mm fiber gratings in a straight line and then physically cutting them back by increments of 1 to 2 mm until the spectral band of the chirped fiber grating changed in a measurable manner. The spectrometer used to support these tests was an Ibsen I-MON 400 that can be operated at 200 Hz over the 1520 to 1580 nm spectral band. This was very useful in providing real time feedback during the cut back tests.

Each of the fiber gratings tested was cut back from the longer wavelength end until a clear transition in response was observed. This allowed an unambiguous starting point for the chirped fiber grating sensor position. Plotting the response via a cut back test also allowed the overall position and effective length of the chirped fiber grating to be established.

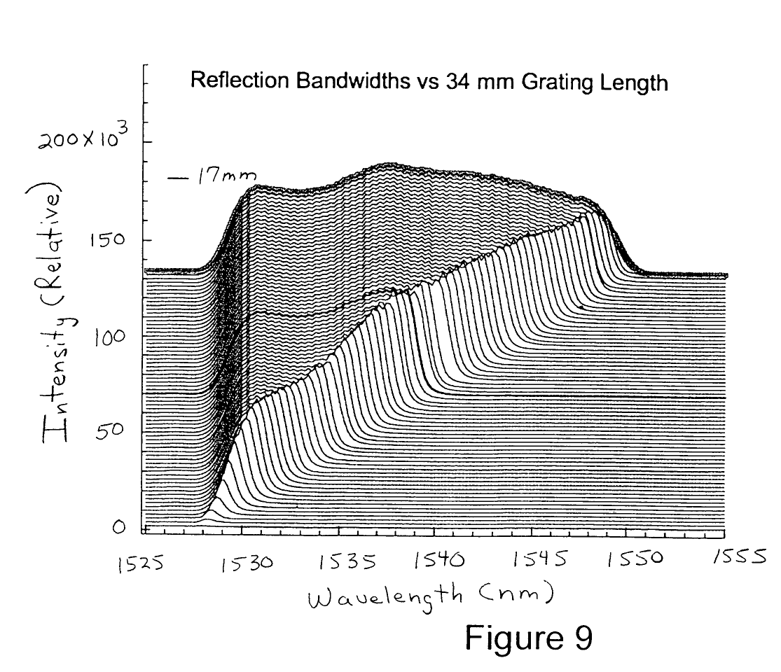

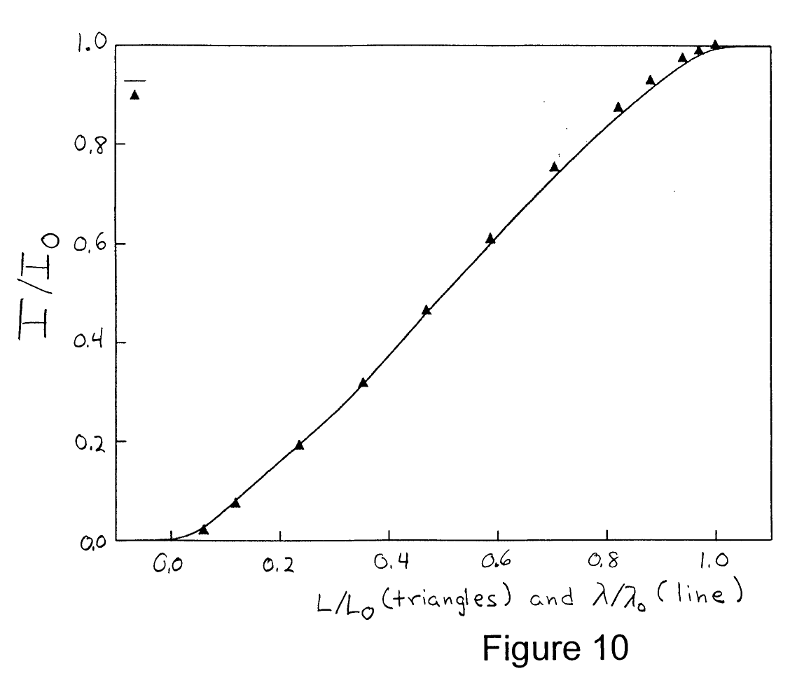

The cut back method, via mechanical or laser trimming can be used to establish the exact position of the fiber grating ends in terms of significant spectral bandwidth change. This information in turn can be used in coordination with the fiber grating manufacturer to optimize the performance of the chirped fiber gratings which in turn will result in improved velocity and position information. FIG. 9 shows a waterfall plot of the reflected spectrum from a chirped fiber grating that is laser trimmed in length. FIG. 10 shows actual data obtained from the spectral reflections of the cut back chirped fiber grating to be in good agreement with the numerical integration of the chirped fiber grating spectral bandwidth.

When a fiber grating is exposed to a pressure it will compress, the overall period of the fiber grating will shorten and the spectrum will shift toward short wavelengths. By setting up a system with a linear filter such as a linear chirped fiber grating filter this shift may be measured and the local pressure inferred.

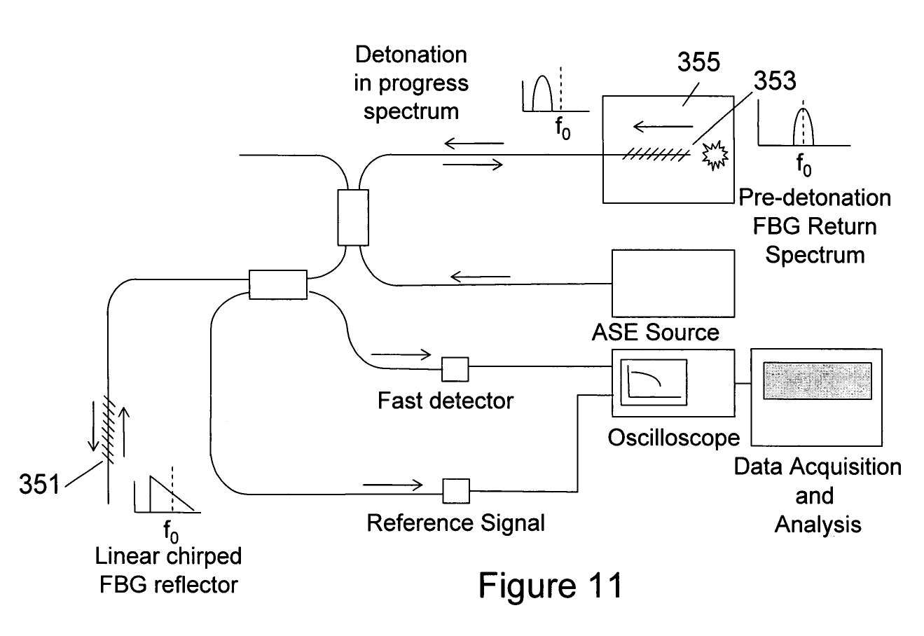

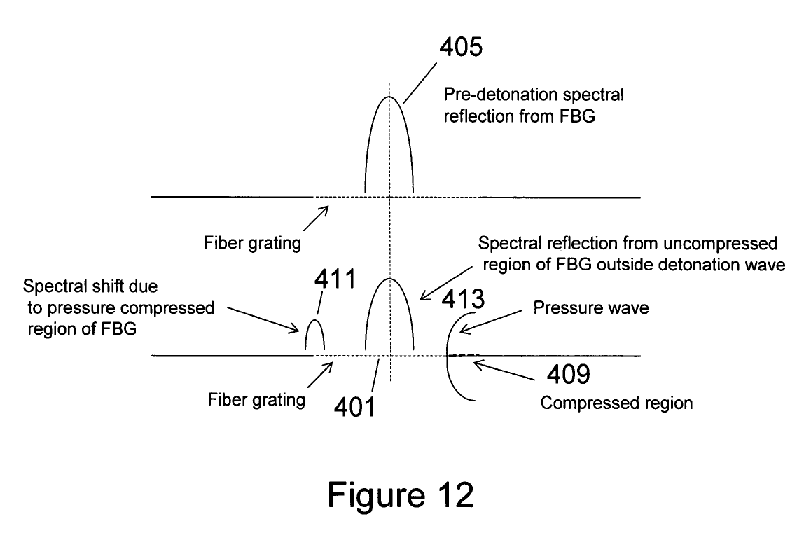

Consider the system block diagram shown in FIG. 11. In this case a linear filter 351 that may be chirped fiber grating filter is used as a reflector. For simplicity in this diagram the length of a fiber grating 353 with uniform index of refraction variations is assumed to have a short length relative to the leading edge pressure wave 355. In general this would not be the case and this will be expanded upon in association with FIG. 12. Before detonation the fiber grating sensor 353 spectrum is at a nominal wavelength fₒ. When after detonation the pressure wave 355 passes, the fiber grating 353 is compressed and there is an overall spectral shift toward shorter wavelengths. Because of the slope of the reflective filter 351 this short wavelength shift results in an increase in the amplitude of the light reflected from the reflected filter 351 that in turn can be used to interpret the pressure wave 355 amplitude. When the blast wave passes, the fiber grating is destroyed. The overall reflected amplitude drops to zero when the pressure wave 355 passes if it is energetic enough to destroy the fiber grating 353.

A more typical case would involve a fiber grating with a uniform period whose length is long compared to the leading edge pressure segment associated with the pressure or blast wave. This situation is illustrated by FIG. 12. The top portion of FIG. 12 shows a uniform fiber grating 401 in an optical fiber 403 before detonation with an associated reflective spectral profile 405. After detonation a pressure wave 407 is initiated from the right and the leading edge pressure wave propagates over a portion 409 of the fiber grating 401. If the assumption is made that the leading edge of the pressure wave 407 is very small and the pressure behind it is uniform then the region of the fiber grating that is under compression will have a smaller period and a portion 411 of the overall spectrum 405 from the fiber grating 401 will be shifted toward shorter wavelengths. If the total spectrum from the fiber grating 401 is measured then the portion 411 of the fiber grating 401 under pressure may be determined by the relative amplitude of the spectral peaks 411 and 413 where 413 has the same spectral position as the spectral peak 405 but lower amplitude. The very fast system associated with FIG. 11 captures an average spectral shift so information conveyed by this system is a combination of the magnitude of the pressure wave and how much of the fiber grating 401 is under this increased pressure. However a very fast spectrometer could be used to monitor the spectral output of the fiber grating. In this case the detailed information of the position and amplitude of the pressure wave could be captured.

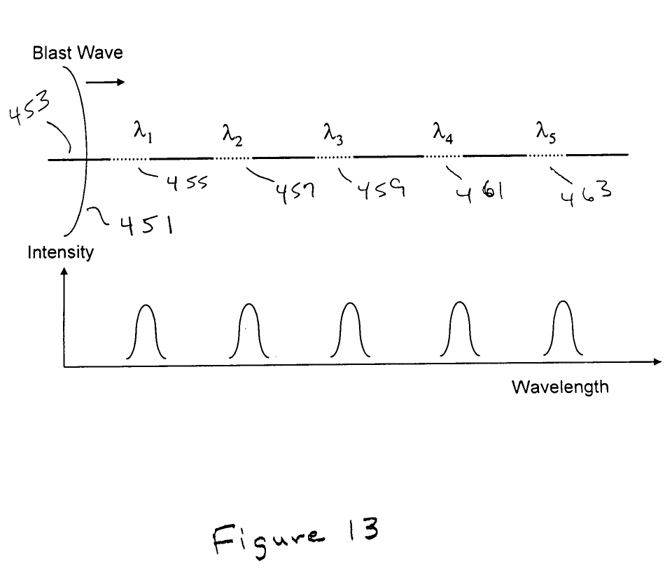

FIG. 13 shows a pressure wave 451 that may be a blast wave traveling along the length of an optical fiber 453 that contains a series of fiber gratings 455, 457, 459, 461 and 463. These fiber gratings 455, 457, 459, 461 and 463 may be arranged so that their reflective wavelength spectral bands do not overlap. If the pressure wave 451 is of sufficient strength to destroy the fiber gratings 455, 457, 459, 461 and 463 in sequences while they are all illuminated by a broadband source then the amplitude of the return signal will drop suddenly with their disappearance enabling position markers that may be used to determine the position and velocity of the pressure wave 451. By varying the amplitude, spacing and wavelength of the fiber gratings 455, 457, 459, 461 and 463 as well as other supporting fiber grating in the optical fiber 453 it would be possible to develop a large set of “markers” to support velocity and position measurements.

The fiber gratings 455, 457, 459, 461 and 463 however also have the potential to enable detailed measurements of the shape of the pressure wave 453 that may be a blast wave.

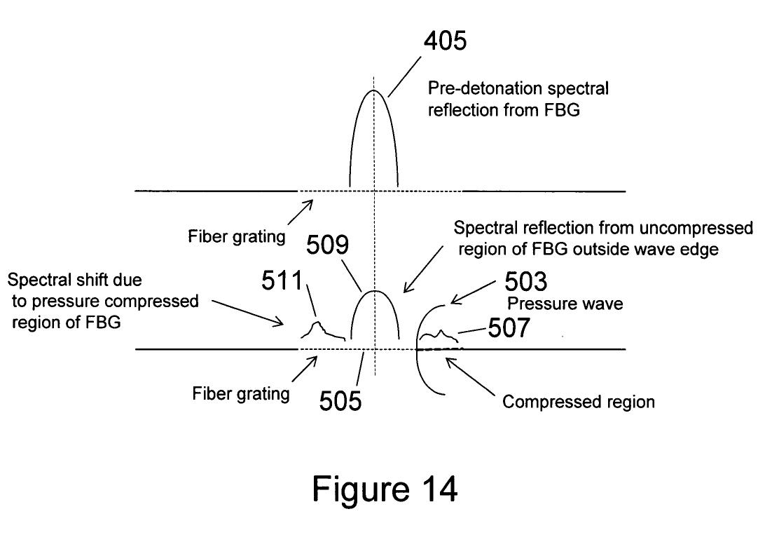

FIG. 14 shows a fiber grating spectral profile 501 prior to detonation and the generation of a pressure or blast wave. Because the pressure or blast wave 503 may not be uniform when it passes over a fiber grating 505 there will be a region 507 of the fiber grating 505 where the fiber grating is compressed in a non-uniform manner. The result is that the original fiber grating spectral profile 501 will be split into two spectral profiles; the spectral profile 509 corresponding to the region where the fiber grating 505 remains uniform as the pressure wave has not reached it and the spectral profile 511 corresponding to the region 507 of the fiber grating 505 that is compressed. The details of the spectral profile 511 can in turn be used to aid in the interpretation of the pressure distribution behind the pressure or blast wave 503.

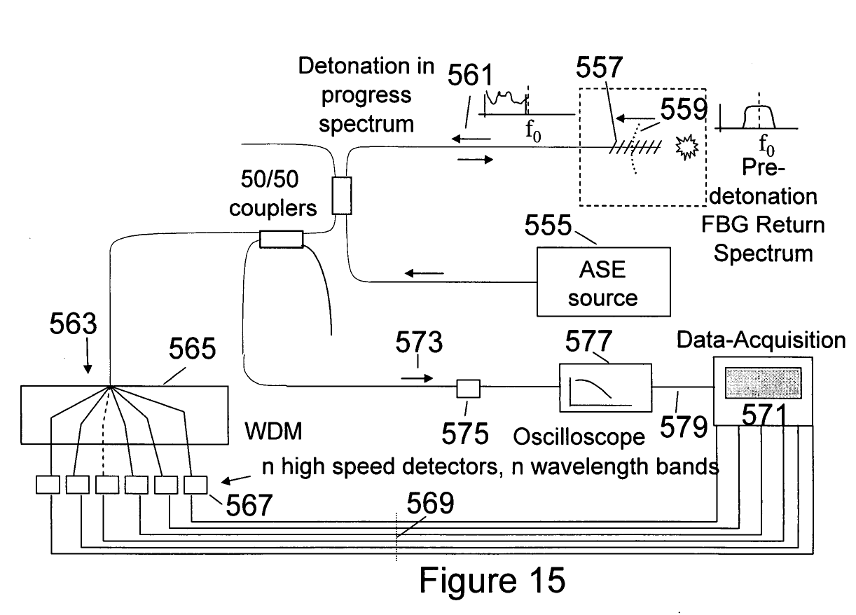

In order to make these spectral profile measurements at high speed a system similar to that associated with FIG. 15 may be employed. The major elements of this Figure are similar to those described in association with FIGS. 5 and 8. A broadband light source 555 is used to illuminate a fiber grating 557 that may be a chirped fiber grating or a series of discrete fiber gratings. When a pressure or blast wave 559 passes through the fiber grating 559 a complex spectral profile associated with compression regions associated with the fiber grating 559 results. The reflective spectrum 561 passes through a set of beamsplitters and is directed as the reflective light beam 563 toward a wavelength division multiplexing (WDM) element 565 that might be a bulk optic grating or series of bulk optic gratings. The WDM element spread the spectrum associated with the light beam 563 across a series of n discrete spatially displaced high speed detectors 567 whose outputs 569 are directed to a data acquisition unit 571 where they can be captured, processed and displayed. A second portion of the reflected light beam 561 is directed through a series of couplers as the light beam 573 which is in turn converted to an electrical signal by the detector 575. The output from the detector 575 is then directed into a data acquisition unit 577 that may be an oscilloscope to display the time varying amplitude of the output signal associated with the pressure or blast wave 559. The output 579 from the unit 577 may be used as a trigger or timing signal for the data acquisition unit 571.

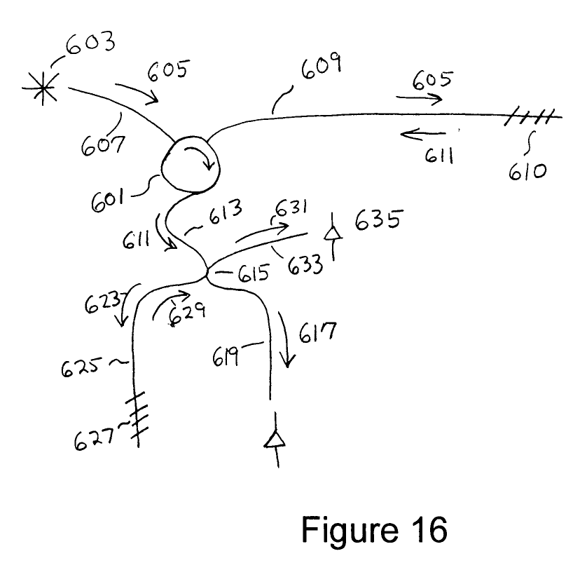

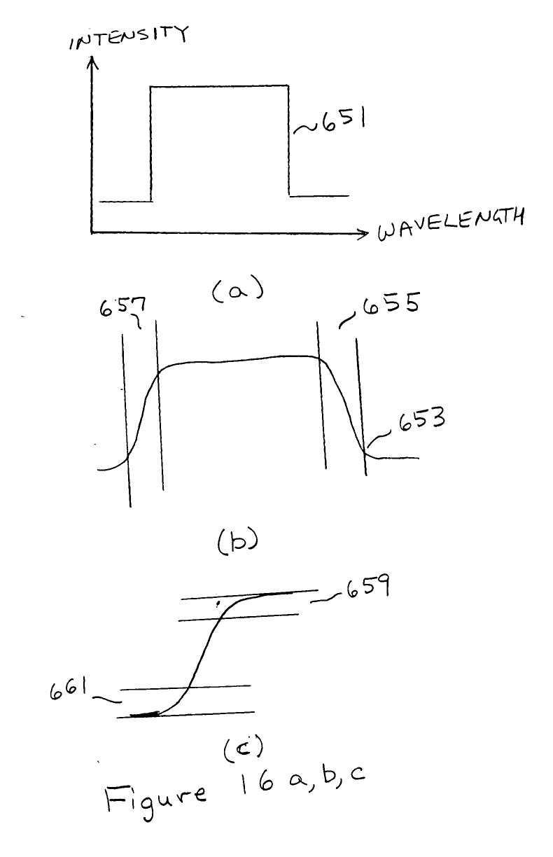

FIG. 16 is an illustration of how a three port circulator 601 may be used in place of the first beamsplitter associated with FIGS. 5, 8 and 14. In this case a broadband light source 603 inputs a light beam 605 into the optical fiber 607 that directs it into the circulator 601. The light beam 605 is then directed into the optical fiber 609 to the test fiber grating 610 that may be a chirped fiber grating or array of fiber gratings. The reflected spectral signature 611 is then directed back to the 3 port circulator 601 and into the optical fiber 613 to the fiber beamsplitter 615 where it is split into the first output light beam 617 that is directed by the optical fiber 619 to the reference detector 621. The second output light beam 623 is directed into the optical fiber 625 and reflected off the reference reflector 627 that is spectrally matched to the test fiber grating 610 and may be a dielectric reflector or a chirped fiber grating. The reflected light beam 629 is directed back through the beamsplitter 615 and a portion of it is directed as the light beam 631 into the optical fiber 633 to the output detector 635. The main advantage of using a 3 port circulator is that it increases the overall optical efficiency of the system increasing signal to noise ratio.

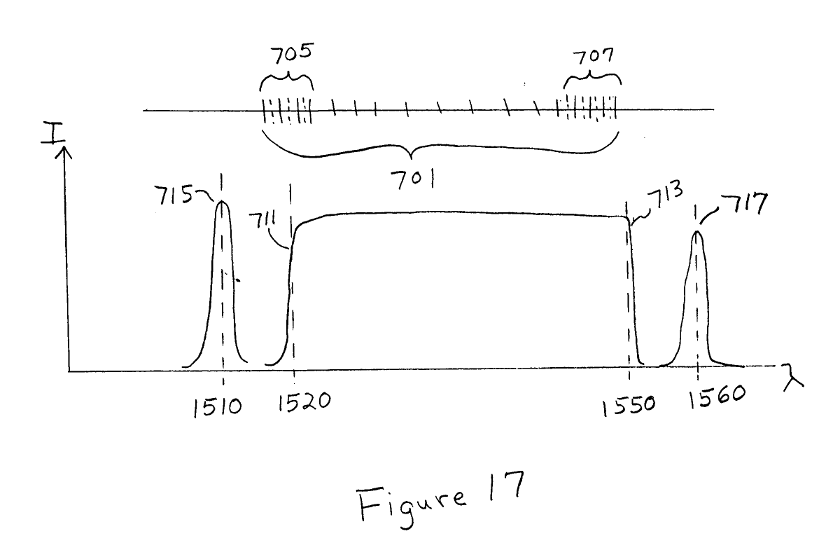

For optimum performance it is highly desirable to be able to very accurately know the physical position of the chirped fiber grating in the optical fiber. This physical position in turn is very important in being able to fully characterize a pressure wave or blast wave passing through the chirped fiber grating sensor. In general it would be highly desirable to have a chirped fiber grating that has a spectral profile 651 with very sharp edges as shown in FIG. 16a. Most chirped fiber grating have spectral profiles that are more similar to the spectral profile 653 shown in FIG. 16b. Here the edges of the spectral profile 653 are much less well defined as illustrated by the transition zones 655 and 657 in FIG. 16b and the zones 659 and 661 in FIG. 16c. When a pressure or blast wave passes these transition zone regions the measurements have more noise and the errors in these regions are larger. One solution is to physically trim the fiber grating to eliminate the transition zone on the edge of the chirped fiber grating facing the oncoming pressure or blast wave. This can be done by cutting or trimming the chirped fiber grating with mechanical cutters or laser trimming. This results in a much sharper spectral profile edge as shown in association with FIGS. 5 and 9. The cutting or laser trimming approach is most practical for the edge facing the blast wave. To cut or trim the other edge of the chirped fiber grating to attain a similar result it would then be necessary to cut or trim and then splice the other end. The splicing procedure could damage the spectral profile and produce a mechanically weak junction. A method to avoid this problem is shown in FIG. 17. Here a chirped fiber grating 701 is written into an optical fiber 703. At each physical end of the chirped fiber grating 701 short length fiber gratings 705 and 707 are written with a period that is distinct from those associated with the chirped fiber grating 701. The spectral profile 709 corresponding to the chirped fiber grating 701 is broad and has transition zones 711 and 713 that have higher noise. The profiles 715 and 717 of the shorter fiber gratings 705 and 707 respectively provide clear measurement points for the start and end of the chirped fiber grating.

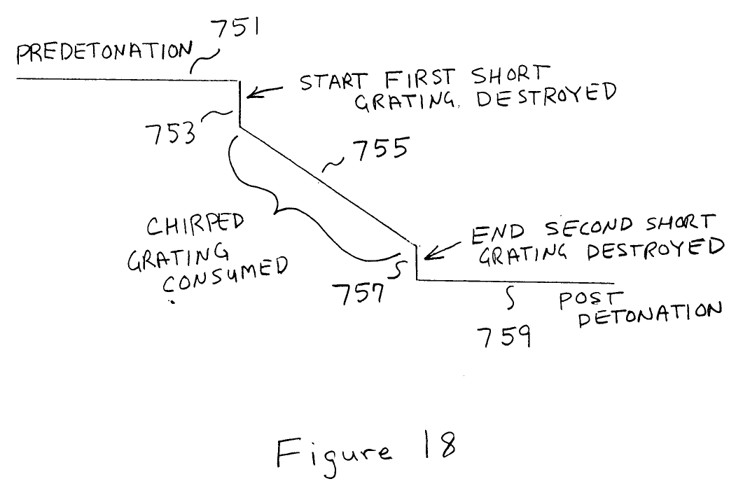

FIG. 18 shows the amplitude of the reflected signal as a pressure or blast wave propagates along the length of the optical fiber 703 destroying the fiber gratings 707, 701 and 705. Before detonation the reflected signal level 751 has constant amplitude. When the short fiber grating 707 is destroyed the amplitude drops rapidly in the region 753. As the pressure or blast wave propagates through the chirped fiber grating 701 destroying it as is propagates through the amplitude decreases with a fairly linear slope in region 755. When it reaches the second short fiber grating 705 there again is a sharp drop in amplitude in the region 757. After the event is over the amplitude of the output signal again is constant in the region 759.

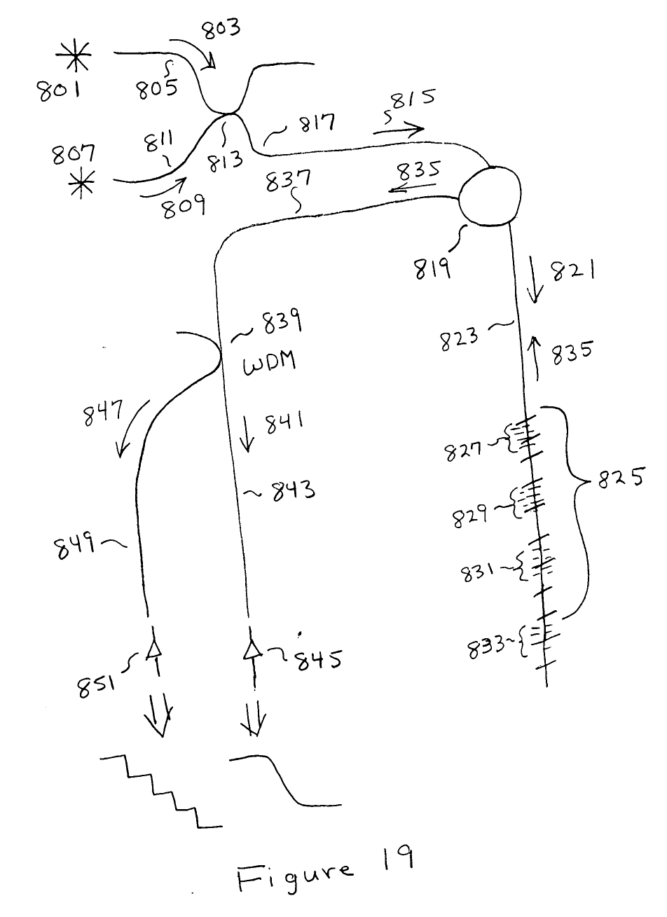

In general n “marker” fiber gratings could be used across a chirped fiber grating to determine distinct points at which a pressure or blast wave crossed. It is also not necessary for the “marker” or chirped fiber gratings to use the same light source or the same wavelength band. FIG. 19 illustrates a configuration where the “marker” fiber gratings are supported by a separate light source and detection system. A light source 801 that may be a broadband light source at 1550 nm is used to launch a light beam 803 into the optical fiber 805. A second light source 807 operates on a distinct wavelength band from light source 803 and may be broadband and operating at 1300 nm launches a light beam 809 into the optical fiber 811. The light beam 803 cross couples across the wavelength division multiplexing (WDM) element 813 and combines with the light beam 811 to form a new light beam 815 that is directed into the optical fiber 817. A portion of the light beam 815 passes through the beam directing element 815 that may be a broadband fiber beamsplitter or a broadband 3 port circulator and continues on as the light beam 821 into the optical fiber 823 that contains a chirped fiber grating 825 that may be centered in the 1550 nm band and a series of “marker” short fiber gratings 827, 829, 831 and 833. The reflected light beam 835 then is directed back by the beam direction element 819 to the optical fiber 837 that is attached to the WDM element 839. A portion 841 of the light beam 835 that may be at 1550 nm is then directed to the optical fiber 843 to the optical detector 845 that is used to monitor the chirped fiber grating 825. A second light beam 847 that may be at 1300 nm is directed into the optical fiber 849 and the output optical detector 851 that is used to monitor the output of the “marker” fiber gratings 827, 829, 831 and 833. In this way the “marker” and chirped fiber grating reflections may be monitored independently and in combination to improve localization and characterization of a pressure or blast wave.

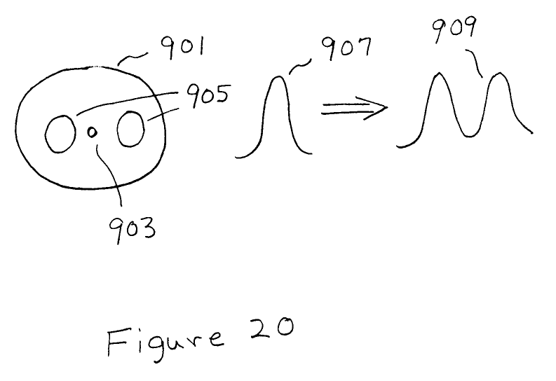

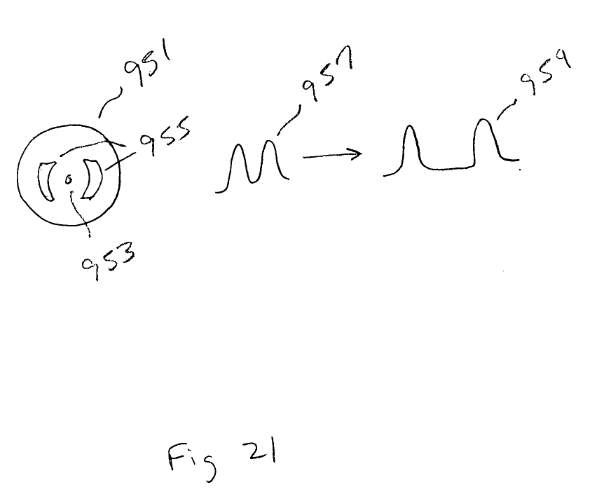

In addition to pressure, velocity and position another important parameter to be monitored during passage of a pressure or blast wave is the local temperature. FIG. 20 illustrates the cross section of a sidehole optical fiber 901. The core 903 of this type of optical fiber is surrounded by two air holes 905. A fiber grating written onto this type of optical fiber generates a single peak spectral profile 907 when the fiber core 903 has low birefringence. If the section of sidehole optical fiber with the fiber grating is spliced to ordinary single mode optical fiber capping the air holes 905 and pressure is applied the birefringence of the core changes. The result is a dual spectral peak profile 909 where the peak to peak spectral split is proportional to pressure and the overall spectral position depends on temperature (and axial strain if it is present). By isolating the optical fiber 901 from axial strain pressure and temperature may be monitored simultaneously. An alternative approach to measuring pressure and temperature simultaneously with a fiber grating involves writing the fiber grating onto birefringent optical fiber 951 that may be commercially available polarization preserving optical fiber shown in FIG. 21. The core 953 of the birefringent optical fiber 951 may have stress inducing elements 955 that induce a differential stress across the core 953. The result is that in the absence of pressure the spectral profile 957 of the fiber grating has a dual peak structure. When pressure is applied the relative birefringence will increase the separation of the peaks will change as in the spectral profile 959. The peak to peak separation and overall spectral position of the spectral peaks may be used to measure pressure and temperature in the absence of axial strain.

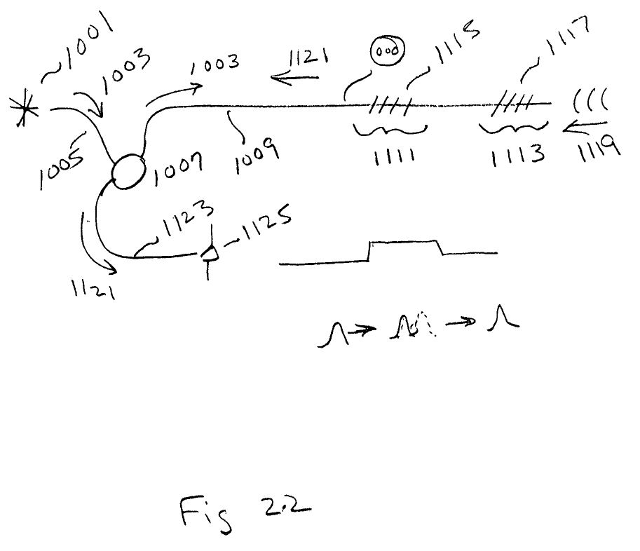

If a very fast spectral read out system may be used such as that illustrated by FIG. 15 then the spectral profiles of the fiber gratings written into sidehole or birefringent optical fibers and described in association with FIGS. 20 and 21 may be used to measure pressure and temperature. There may however be cases where the events are very fast and a single point detector system can be constructed to support measurements of these extremely fast events. In this case the system shown in FIG. 22 may be used. A light source 1001 that may be broadband is used to couple a light beam 1003 into an optical fiber 1005. The light beam 1003 is directed to a beam directing element 1007 that may be a 3 port optical circulator or a fiber beamsplitter and in turn is directed to the optical fiber 1009 that contains sections of sidehole optical fiber 1111 and 1113 that are capped with fusion splices to conventional single mode fiber on both ends and have fiber gratings 1115 and 1117 written onto them. The fiber gratings are written at the same wavelength, with the same spectral profile and designed to have high reflectivity that may be higher than 50%. Before pressure is applied to the optical fiber 1009 by a pressure or blast wave 1119 the first fiber grating 1115 blocks a portion of the light beam 1003 from reaching the fiber grating 1117. When the pressure or blast wave 1119 reaches the fiber grating 1117 it causes the spectral profile of the fiber grating 1117 to split and shift so that it moves out the spectral profile “shadow” caused by the fiber grating 1115 and the net reflective signal 1121 from the light beam 1003 increases until the fiber grating 1117 is destroyed. If the spectral profile of the fiber grating 1115 is designed to completely “shadow” the spectral profile of the fiber grating 1117 then these reflective amplitude transitions may be sharply defined. The reflected light beam 1121 returns to the beam directing element 1007, that may be a 3 port circulator, and is directed to the optical fiber 1123 and the output detector 1125.

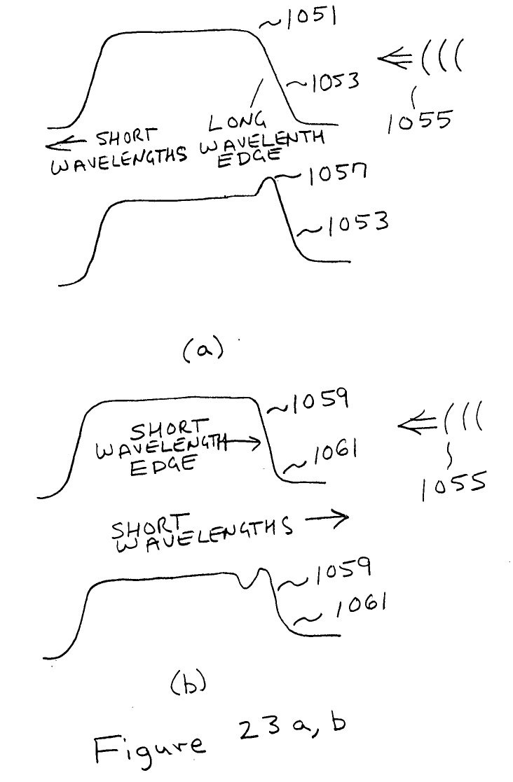

When a pressure or blast wave encounters the end of a chirped fiber grating there may be a portion of the fiber grating subject to compression before it is destroyed by passage of the wave if it is of sufficiently high amplitude. FIG. 23 illustrates that the spectral shape changes associated with the chirped fiber grating will be different depending on whether the short or long wavelength end is directed toward the incoming direction of the blast wave. FIG. 23a shows the spectral profile 1051 with the long wavelength edge 1053 corresponding to the end nearest the blast wave 1055. When the blast wave 1055 encounters the long wavelength edge 1053 of the chirped fiber grating it is compressed and shifts toward shorter wavelengths which if the chirped fiber grating is designed to have moderate reflectivity that may be between 20 and 80% then the spectral profile 1051 near the long wavelength edge will have a higher reflectivity region 1057 or bump whose amplitude will be proportional to the pressure rise. In FIG. 23b the spectral profile 1059 of a chirped fiber grating has the short wavelength edge 1061 directed toward the pressure or blast wave 1055. In this case when the blast wave encounters the short wavelength edge it compresses a region of the chirped fiber grating near the edge 1061 and drives the spectral profile away from the main profile resulting in a dip 1063 again providing a means to measure pressure.

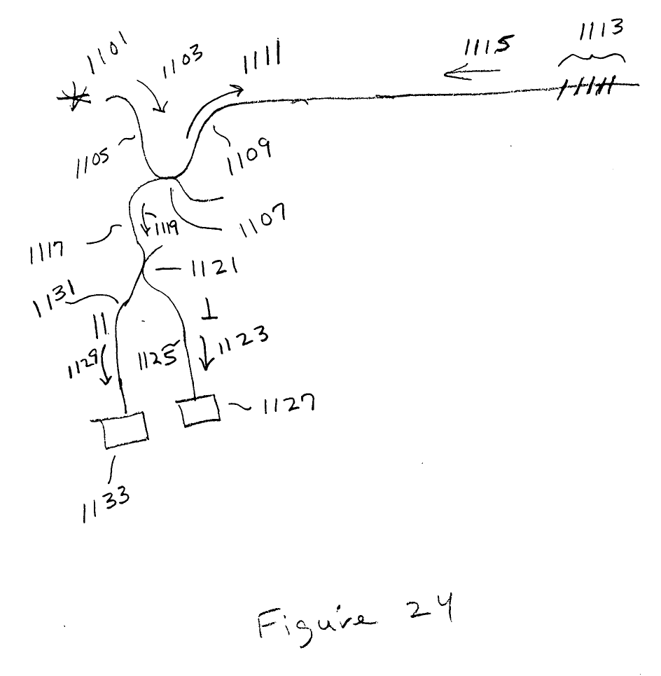

While the shifts of due to the pressure or blast wave are likely to be principally pressure they may also be due in part to temperature. By using polarization maintaining fiber throughout a system such as that shown on FIG. 24 and a fast detector array to measure the entire spectral profile (see FIG. 15) both parameters could be measured by extracting two distinct signatures corresponding to each of the polarization states. In FIG. 24 a broadband light source 1101 is used to launch a light beam 1103 into a polarization preserving fiber lead 1105. The light beam enters a polarization preserving beam guiding element 1107 that may be a polarization preserving beamsplitter or polarization preserving 3 port circulator. A portion of the light beam 1103 is directed into the polarization preserving fiber lead 1109 as the light beam 1111 and directed to the fiber grating sensor assembly 1113 that may be a chirped fiber grating, an array of short length fiber gratings or a combination of both. The reflected light beam 1115 from the fiber grating sensor assembly 1113 is directed back into the beam guiding element 1107 and a portion of the light beam 1115 is directed into the polarization preserving fiber leg 1117 as the light beam 1119. The polarizing coupler 1121 then splits out the two orthogonal polarization states of the light beam 1119 into the light beam 1123 that is launched into the optical fiber lead 1125 and directed toward the first output detector 1127, and the light beam 1129 that is coupled into the optical fiber 1131 and directed into the second output detector 1133.

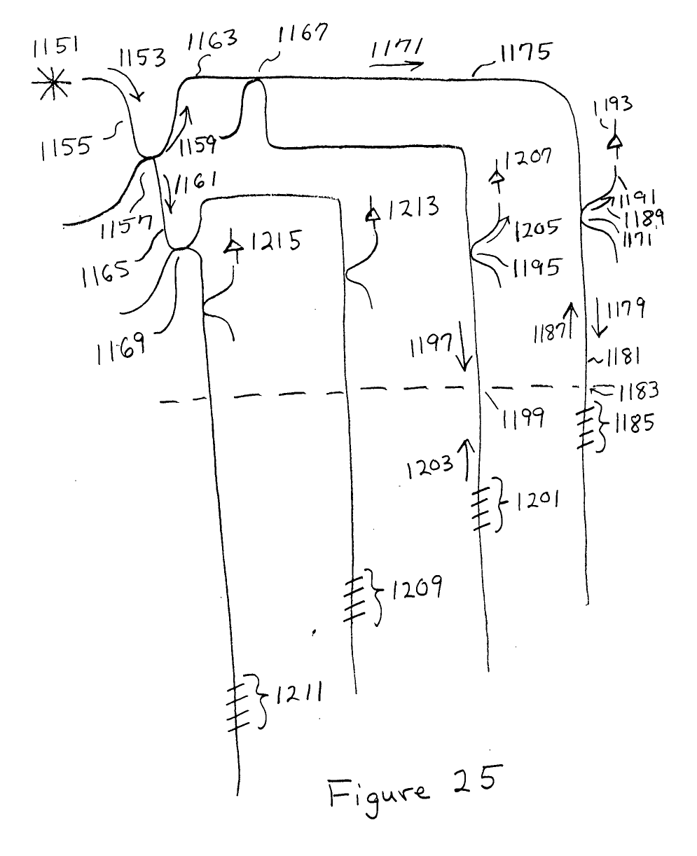

For lowest possible cost and the highest degree of flexibility it is desirable to produce in large quantities fiber grating sensors that have similar characteristics. As an example a fiber grating fabrication system might be set up with a set of phase masks to produce 100 mm long chirped fiber gratings centered about 1550 nm with out of chirped fiber grating spectral band short length marker fiber gratings incorporated into the chirp fiber grating physical structure. This could be done with a single phase mask and a production line set up to write fiber gratings of this type onto 1 m lengths of optical fiber. A single fiber grating system of this type could be used to monitor a 100 mm length. But there are cases where it is desirable to be able to measure highly energetic pressure waves over longer lengths over distances of 200 mm, 400 mm or longer. It is possible to make longer chirped fiber gratings but the costs go up with longer lengths and there are costs associated with each new fabrication set up. Instead of this more costly procedure standard measurement systems can be set up to support 2, 4, 8 and higher numbers of the shorter fiber gratings using multiple fibers that offer the user flexibility in terms of the length of the region to be measured as well as the flexibility to make measurement of different regions of a material. FIG. 25 shows a system configured to support four single fibers each of which may have an identical fiber grating sensor assembly. A broadband light source 1151 launches a beam of light 1153 into an optical fiber 1155 that is attached to a first fiber coupler 1157 that splits the light beam 1153 into the light beams 1159 and 1161 that are in turn directed via the optical fibers 1163 and 1165 to the second fiber coupler 1167 and the third fiber coupler 1169. The fiber coupler 1167 splits the light beam 1159 into the light beams 1171 and 1173. The light beam 1171 propagates along the optical fiber 1175 to a fourth coupler 1177 and a portion of the light beam 1171 continues onward as the light beam 1179 via the optical fiber 1181. The light beam 1179 then passes through an optical fiber connection 1183 that may be a physical optical fiber connector or a fusion splice, and onto a fiber grating sensor assembly 1185. The reflected optical light beam 1187 from the fiber grating sensor assembly is then directed back through the connection 1183 to the coupler 1177 and a portion of it becomes light beam 1189 that is directed via the optical fiber 1191 to the output detector 1193 where it is converted to an electrical signal. Similarly the light beam 1173 is directed though the coupler 1195 and a portion of it becomes light beam 1197 that propagates though the connection 1199 and onto the fiber grating sensor assembly 1201 and reflects back as the light beam 1203 past the connection 1199 to the coupler 1195 where a portion of it is split into the light beam 1205 that falls onto the output detector 1207. The third fiber grating assembly 1209 and the fourth fiber grating assembly 1211 are monitored in a similar manner by light beams reflecting off them and a portion being directed toward the output detectors 1213 and 1215 respectively.

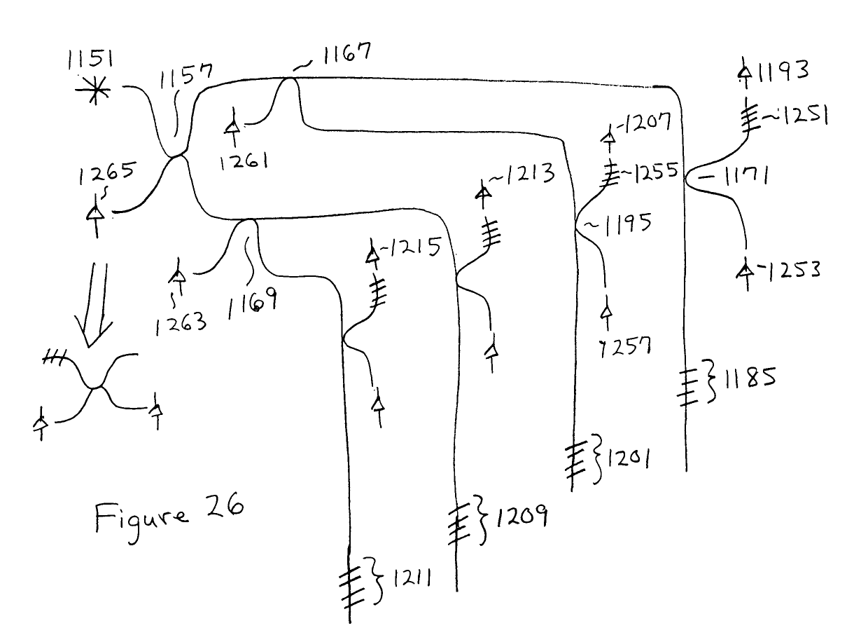

The system shown in FIG. 26 is an extension of that shown and described in association with FIG. 25. In addition to the elements that are common to both systems, the system of FIG. 26 has the spectral filter element 1251 in front of the output detector 1193, this could be a chirped fiber grating filter with a sloping spectral profile and a second detector 1253 to monitor the reflection of the light off the filter 1251. In a similar manner the fiber grating sensor assembly 1201 is monitored by the output detector 1207 in combination with the filter 1255 and the second detector 1257. Similar arrangements are made to support monitoring the fiber grating sensor assemblies 1209 and 1211. The motivation for the filter combinations is to filter out any stray light associated with energetic events and to provide options for different shaped filters that can be used to provide details at high speed of how the spectral profiles of the fiber grating sensor assemblies are changing allowing such parameters as pressure changes to be inferred. In addition the three detector positions 1261, 1263 and 1265 can be used to monitor the amplitude of the return signals from the fiber grating sensor assemblies 1185, 1201, 1209 and 1211, either in pairs in the case of 1261 and 1263 or all four in the case of 1265. These detector positions 1261, 1263 and 1265 can be supported by single detector elements or pairs of detectors with filter assemblies similar to those described earlier. Which combination of detectors is most desirable depends on the specifics of the test parameters to be measured, the speed and accuracy of the electronic support equipment used to support the test and the physical displacement of the fiber grating sensor assemblies. Both the systems shown in FIGS. 25 and 26 offer the end user considerable flexibility in supporting a wide variety of measurements using a “standard” fiber grating sensor assembly.

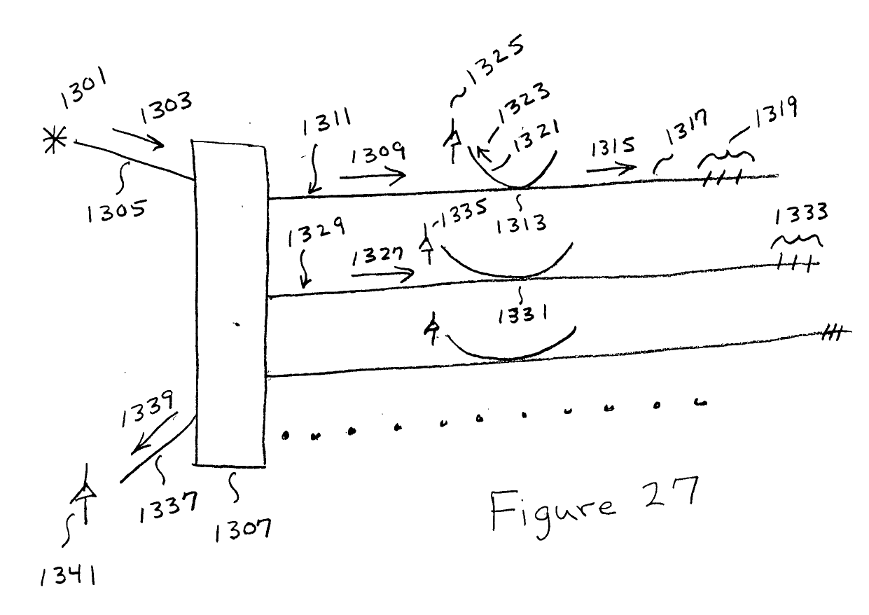

The systems described in association with FIGS. 25 and 26 can be extended to n fiber lines. FIG. 27 shows a light source 1301 that couples a beam of light 1303 into an optical fiber end 1305 which directs the light beam 1303 to the n port coupler 1307. The light beam 1303 is divided by the n port coupler into n light beams the first of which light beam 1309 is directed into the optical fiber 1311 where it is directed to the fiber coupler 1313. A portion of the light beam 1309 is then split by the fiber coupler 1313 into the light beam 1315 that is propagates down the optical fiber 1317 to the fiber grating sensor assembly 1319. A portion of the light beam 1315 is then directed back to the fiber coupler 1313 and a portion of it is directed by the fiber coupler 1313 into the optical fiber 1321 as the light beam 1323 which falls onto the output detector 1325. In a similar manner the light beam 1327 is directed into the second fiber line 1329 to the coupler 1331 that directs a portion of the light beam 1327 to the fiber grating assembly 1333 where whose reflected signal is directed as a new beam to the output detector 1335 by the fiber coupler 1331. Each of the n lines associated with this system have similar elements and operation. If the fiber grating assemblies associated with the system of FIG. 27 are spaced sufficiently and the high speed event is sufficiently energetic so that the fiber grating assemblies are destroyed then a single optical fiber output 1337 from the n port coupler 1307 may be used to direct a light beam 1339 from the n fiber grating sensor assemblies to an output optical detector 1341 that can be used to support monitoring the high speed event.

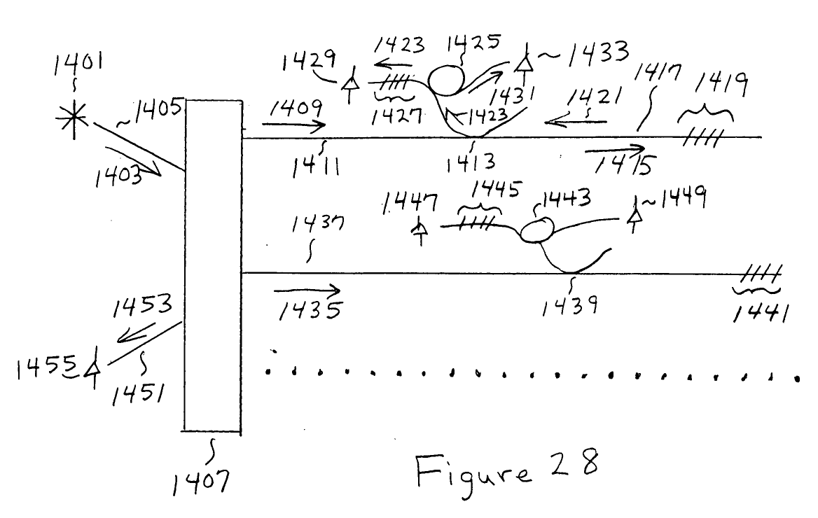

FIG. 28 shows another system that extends the capabilities of that associated with FIG. 27. Here the light source 1401 couples a beam of light 1403 into an optical fiber 1405 that serves as the input port to the n output port coupler 1407. A portion of the light beam 1403 is split into the light beam 1409 that is coupled into the optical fiber 1411 and propagates past the fiber coupler 1413 and a portion of the light beam 1409 is split into the light beam 1415 that is coupled into the optical fiber 1417 that contains the fiber grating sensor assembly 1419. A portion of the light beam 1415 reflects off the fiber grating sensor assembly 1419 as the light beam 1421 and enters the fiber coupler 1413. A portion of light beam 1421 is then split as light beam 1423 to the beam directing element 1425 that may be a 3 port optical circulator. The light beam 1423 then passes the filter 1427 and a portion of it passes through to the output detector 1429. Another portion reflects from the filter as light beam 1431 and directed by the beam directing element 1425 to the output detector 1433. A second light beam 1435 enters a second optical fiber 1435 that acts as the second output port of the n port coupler 1407 and enters a fiber subassembly consisting of the optical fiber 1437, the fiber coupler 1439, fiber grating sensor assembly 1441, beam directing element 1443, filter 1445 and output detectors 1447 and 1449 that behave in a manner similar to that associated with the first fiber line. Similarly n fiber sensing and detection lines can be supported. The output fiber line 1451 of the n port coupler 1407 can be used to direct the light beam 1453 that captures signals from each of the n fiber grating assemblies which in turn in directed to the output detector 1455.

Thus there has been shown and described a novel system for measuring high intensity pressure or blast waves or other environmental parameters including those that destroy and optical fiber and fulfills all the objectives and advantages sought therefore. Many change, modifications, variations and applications of the subject invention will become apparent to those skilled in the art after consideration of the specification and accompanying drawings. All such changes modifications, alterations and other uses and applications which do not depart from the spirit and scope of the invention are deemed to be covered by the invention which is limited only to the claims that follow:

What is claimed is:

1. A fiber grating sensor assembly with at least one chirped fiber grating and at least one short gauge length marker fiber grating operating in a different spectral region.

2. A fiber grating sensor assembly as in claim 1 where one end of said chirped fiber grating is physically trimmed on one end.

3. A fiber grating sensor assembly as in claim 1 where said marker fiber gratings are positioned near each physical end of said chirped fiber grating.

4. A fiber grating sensor assembly as in claim 1 where said marker fiber gratings are evenly spaced across said chirped fiber grating.

5. A fiber grating sensor assembly as in claim 1 mounted in a positioning tube.

6. A fiber grating sensor assembly as in claim 1 where the marker fiber gratings are spaced unevenly.

7. A fiber grating sensor assembly as in claim 1 where at least one fiber grating is written into side hole optical fiber.

8. A fiber grating sensor assembly as in claim 1 where at least one fiber grating is written into birefringent optical fiber.

9. A high speed fiber grating sensor system capable of measuring and characterizing a high speed event including:
a light source producing a beam of light and
a first fiber beam director with a first end connected to receive said light beam and
a second end of said first beam director connected to at least two fiber gratings having similar spectral profiles, said fiber gratings being positioned to intercept a high speed environmental event and third output port of said first beam director being connected to an optical detector to detect reflected light from said fiber gratings.

10. A high speed fiber grating sensor system as in claim 9 where said fiber gratings are written into side hole optical fiber.

11. A high speed fiber grating sensor system as in claim 9 where said fiber gratings are written into birefringent optical fiber.

12. A high speed fiber grating sensor system as in claim 9 where: said first fiber grating is polarization preserving; said fiber gratings are written into birefringent optical fiber; said third output of said first beam director is connected to an input leg of a polarizing beamsplitter; one output leg of said polarizing beamsplitter being connected to a first output detector to measure the reflected light from said fiber gratings in a first polarization state and second output port of said polarizing beamsplitter being connected to a second output detector to measure the reflected light from said fiber grating in a second polarization state.

13. A high speed fiber grating sensor system for measuring and characterizing high speed events at multiple spatial locations including:
a light source producing a beam of light and a fiber beam director having its first leg positioned to receive said beam of light from said light source and n output port, said first output port being connector to the first leg of a first beamsplitter with a second output leg of said beamsplitter being connected to an optical fiber with a first fiber grating sensor assembly, the reflection of said light beam from said first fiber grating sensor assembly being directed back to said first beamsplitter and via a third output port of first beamsplitter to first output detector and said second output port being connector to the first leg of a second beamsplitter with a second output leg of said second beamsplitter being connected to an optical fiber with a second fiber grating sensor assembly, the reflection of said light beam from said second fiber grating sensor assembly being directed back to said second beamsplitter and via a third output port of second beamsplitter to second output detector and said nth output port being connected to the first leg of an nth beamsplitter with a second output leg of said nth beamsplitter being connected to an optical fiber with an nth fiber grating sensor assembly, the reflection of said light beam from said nth fiber grating sensor assembly being directed back to said nth beamsplitter and via a third output port of nth beamsplitter to nth output detector.

14. A high speed fiber grating sensor system for measuring and characterizing high speed events at multiple spatial locations as in claim 13 including: said first beamsplitter having a first filter inserted before said third port and said first beamsplitter having a fourth output port connected to second output detector to receive the reflection from said first filter and said second beamsplitter having a second filter inserted before said third port and said second beamsplitter having a fourth output port connected to second output detector to receive the reflection from said second filter and said nth beamsplitter having an nth filter inserted before said third port and said nth beamsplitter having a fourth output port connected to second output detector to receive the reflection from said nth filter.

15. A high speed fiber grating sensor system for measuring and characterizing high speed events at multiple spatial locations as in claim 13 including:
said fiber grating sensor assemblies being written into side hole optical fiber.

16. A high speed fiber grating sensor system for measuring and characterizing high speed events at multiple spatial locations as in claim 13 including:
said fiber grating sensor assemblies being written into birefrigent optical fiber.
